(19) United States
(12) Patent Application Publication
(10) Pub. No.: US 2016/0012206 A1
(43) Pub. Date: Jan. 14, 2016

(54) PICTORIAL REPORT OF A MEDICAL PROCEDURE

(71) Applicant: Siemens Medical Solutions USA, Inc., Malvern, PA (US)

(72) Inventors: Soroosh Kargar, Lake in the Hills, IL (US); Weng Lei, Mount Prospect, IL (US)

(21) Appl. No.: 14/327,939

(22) Filed: Jul. 10, 2014

(51) Int. Cl. G06F 19/00

(52) U.S. Cl. CPC G06F 19/3487; G06F 19/321

(57) ABSTRACT

Disclosed herein is a framework for facilitating reporting. In accordance with one aspect, the framework generates a first outline of a first region of interest in pre-procedural image data. The pre-procedural image data may be acquired from a subject before a medical procedure is performed on the subject. The framework may further generate a second outline of a second region of interest in post-procedural image data. The second outline corresponds to the first outline and may be acquired from the subject during or after the medical procedure is performed on the subject. A pictorial report of the medical procedure may then be generated based at least in part on the first and second outlines.

### TECHNICAL FIELD

The present disclosure generally relates to systems and methods for generating a pictorial report of a medical procedure.

### BACKGROUND

Doctors routinely perform medical procedures on patients. A medical report (e.g., operative report) may contain detailed information regarding the medical procedure, and is particularly useful for doctors to explain to the patient the action taken during the medical procedure. Typically, the medical report is dictated by the operating physician and is therefore in the form of text. It may also include a hand drawing by the doctor to illustrate the outcome of the medical procedure. However, it is very time-consuming and difficult to create a medical report that realistically illustrates the procedure.

### SUMMARY

The present disclosure relates to a framework for facilitating pictorial reporting of a medical procedure. In accordance with one aspect, the framework generates a first outline of a first region of interest in pre-procedural image data. The pre-procedural image data may be acquired from a subject before the medical procedure is performed on the subject. The framework may further generate a second outline of a second region of interest in post-procedural image data. The second outline corresponds to the first outline and may be acquired from the subject during or after the medical procedure is performed on the subject. A pictorial report of the medical procedure may then be generated based at least in part on the first and second outlines.

This summary is provided to introduce a selection of concepts in a simplified form that are further described below in the following detailed description. It is not intended to identify features or essential features of the claimed subject matter, nor is it intended that it be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings. Furthermore, it should be noted that the same numbers are used throughout the drawings to reference like elements and features.

FIG. 1 shows an exemplary architecture;

FIG. 2 is a flow diagram illustrating an exemplary pictorial reporting method; and

FIG. 3 shows an exemplary post-procedural image.

### DETAILED DESCRIPTION

In the following description, numerous specific details are set forth such as examples of specific components, devices, methods, etc., in order to provide a thorough understanding of embodiments of the present invention. It will be apparent, however, to one skilled in the art that these specific details need not be employed to practice embodiments of the present invention. In other instances, well-known materials or methods have not been described in detail in order to avoid unnecessarily obscuring embodiments of the present invention. While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

It is to be understood that the system and methods described herein may be implemented in various forms of hardware, software, firmware, special purpose processors, or a combination thereof. Preferably, the present invention is implemented in software as an application (e.g., n-tier application) comprising program instructions that are tangibly embodied on one or more non-transitory program storage devices (e.g., magnetic floppy disk, RAM, CD ROM, ROM, etc.), and executable by any device or machine comprising suitable architecture. If written in a programming language conforming to a recognized standard, sequences of instructions designed to implement the methods can be compiled for execution on a variety of hardware platforms and for interface to a variety of operating systems. In addition, embodiments of the present framework are not described with reference to any particular programming language. It will be appreciated that a variety of programming languages may be used to implement embodiments of the present invention.

It is to be further understood that since at least a portion of the constituent system modules and method steps depicted in the accompanying Figures may be implemented in software, the actual connections between the system components (or the flow of the process steps) may differ depending upon the manner in which the present invention is programmed. Given the teachings herein, one of ordinary skill in the related art will be able to contemplate these and similar implementations or configurations of the present invention.

The present disclosure describes a framework that facilitates pictorial reporting of a medical procedure. The medical procedure may be any type of procedure or intervention performed for diagnostic, surgical or prognostic purposes. The medical procedure may include, for example, structural repair of an organ (e.g., heart) or a diseased blood vessel, or correction of a congenital malformation (e.g., ventricular septal defect). In accordance with one aspect, the present framework automatically generates a pictorial report of the medical procedure and locates the structure change that has been made during the procedure. The doctor who performed the medical procedure need not spend time manually drawing a picture of the structural change that has been made to, for example, the organ or blood vessel. The present framework not only advantageously increases the work efficiency of the doctor, but also improves the quality and accuracy of pictorial reports. These exemplary advantages and features will be described in more detail in the following description.

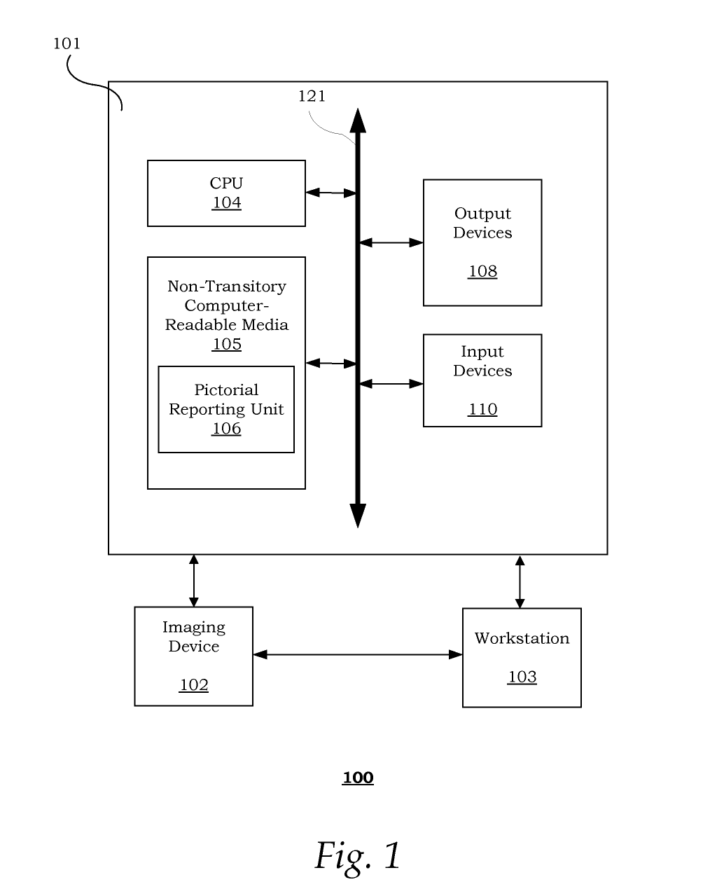

FIG. 1 is a block diagram illustrating an exemplary imaging system 100. The imaging system 100 includes a computer system 101 for implementing the framework as described herein. The computer system 101 may further be connected to an imaging device 102 and a workstation 103, over a wired or wireless network. The imaging device 102 may be a radiology scanner such as a magnetic resonance (MR) scanner, PET/MR, X-ray or a CT scanner.

Computer system 101 may be a desktop personal computer, a portable laptop computer, another portable device, a mini-computer, a mainframe computer, a server, a storage system, a dedicated digital appliance, or another device having a storage sub-system configured to store a collection of digital data items. In one implementation, computer system 101 comprises a processor or central processing unit (CPU) 104 coupled to one or more non-transitory computer-readable media 105 (e.g., computer storage or memory), output devices 108 (e.g., monitor, display, printer, etc.) and various input devices 110 (e.g., mouse, keyboard, touch pad, voice recognition module, etc.) via an input-output interface 121. Computer system 101 may further include support circuits such as a cache, a power supply, clock circuits and a communications bus. Even further, computer system 101 may be provided with a graphics controller chip, such as a graphics processing unit (GPU) that supports high performance graphics functions.

It is to be understood that the present technology may be implemented in various forms of hardware, software, firmware, special purpose processors, or a combination thereof. In one implementation, the techniques described herein are implemented by pictorial reporting unit 106. Pictorial reporting unit 106 may include computer-readable program code tangibly embodied in non-transitory computer-readable media 105. Non-transitory computer-readable media 105 may include random access memory (RAM), read only memory (ROM), magnetic floppy disk, flash memory, and other types of memories, or a combination thereof. The computer-readable program code is executed by CPU 104 to control and/or process image data from imaging device 102.

As such, the computer system 101 is a general-purpose computer system that becomes a specific-purpose computer system when executing the computer readable program code. The computer-readable program code is not intended to be limited to any particular programming language and implementation thereof. It will be appreciated that a variety of programming languages and coding thereof may be used to implement the teachings of the disclosure contained herein. Computer system 101 may also include an operating system and microinstruction code. The various techniques described herein may be implemented either as part of the microinstruction code or as part of an application program or software product, or a combination thereof, which is executed via the operating system. Various other peripheral devices, such as additional data storage devices and printing devices, may be connected to the computer system 101.

The workstation 103 may include a computer and appropriate peripherals, such as a keyboard and display, and can be operated in conjunction with the entire system 100. For example, the workstation 103 may communicate with the imaging device 102 so that the image data collected by the imaging device 102 can be rendered at the workstation 103 and viewed on the display. The workstation 103 may include a user interface that allows a radiologist or any other skilled user (e.g., physician, technician, operator, scientist, etc.), to manipulate the image data. For example, a user may identify points, regions or structures of interest in the image data, or annotate the points, regions or structures of interest using pre-defined descriptors via the user interface. Further, the workstation 103 may communicate directly with computer system 101 to display processed image data. For example, a radiologist can interactively manipulate the displayed representation of the processed image data and view it from various viewpoints and in various reading modes.

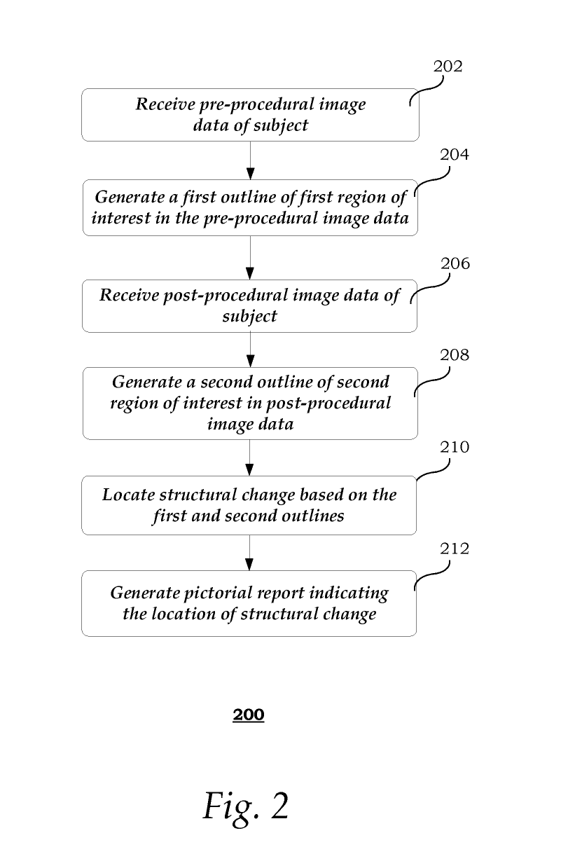

FIG. 2 shows an exemplary method 200 of generating pictorial reports. It should be noted that the steps of the method 200 may be performed in the order shown or a different order. Furthermore, different, additional or fewer steps may be implemented. Even further, the method 200 may be implemented with the system 100 of FIG. 1, a different system, or a combination thereof.

At 202, pictorial reporting unit 106 receives pre-procedural image data of subject (e.g., patient). The pictorial reporting unit 106 may receive the pre-procedural image data from, for example, the imaging device 102, a storage device, a database system or an archiving system, such as a picture archiving and communication (PAC) system. The pre-procedural image data may be acquired by, for example, the imaging device 102 before a medical procedure is performed on the subject. The image data may be acquired using techniques such as magnetic resonance (MR) imaging, computed tomography (CT), helical CT, X-ray, angiography, positron emission tomography (PET), fluoroscopy, ultrasound, single photon emission computed tomography (SPECT), etc., or a combination thereof.

At 204, pictorial reporting unit 106 generates a first outline of a first region of interest (ROI) in the pre-procedural image data. The first region of interest may be, for example, a blood vessel or an organ (e.g., heart) of the subject. The first outline may be generated by automatically or semi-automatically segmenting the first ROI. Exemplary segmentation techniques include, but are not limited to, fixed value thresholding, region growing, or any other applicable segmentation methods. For example, the first outline may be generated by a segmentation technique that detects points with voxel intensities above a pre-determined threshold. Alternatively, or additionally, the segmentation technique may detect the first ROI around one or more points indicated by, for example, a user via a user-interface at workstation 103 during or after the procedure. The segmentation technique may analyze the one or more points, detect and highlight the outline of the first ROI surrounding the one or more points. The user may then choose to modify the first outline via, for example, the user-interface at workstation 103, to improve accuracy.

At 206, pictorial reporting unit 106 receives post-procedural image data of the subject. The pictorial reporting unit 106 may receive the post-procedural image data from, for example, the imaging device 102, a storage device, a database system or an archiving system, such as a picture archiving and communication (PAC) system. The post-procedural image data may be acquired by, for example, the imaging device 102 during or after the medical procedure is performed on the subject. In some implementations, the post-procedural image data is acquired using the same techniques used to acquire the pre-procedural image data. The post-procedural image data may be acquired using, for example, magnetic resonance (MR) imaging, computed tomography (CT), helical CT, X-ray, angiography, positron emission tomography (PET), fluoroscopy, ultrasound, single photon emission computed tomography (SPECT), etc., or a combination thereof.

At 208, pictorial reporting unit 106 generates a second outline of a second region of interest (ROI) in the post-procedural image data. The second ROI corresponds to the first ROI in the pre-procedural image data. The second ROI may represent, for example, the same blood vessel or organ (e.g., heart) of the same subject as the first ROI. The second outline may be generated by automatically or semi-automatically segmenting the second ROI. Exemplary segmentation techniques include, but are not limited to, fixed value thresholding, region growing, or any other applicable segmentation methods. For example, the second outline may be generated by a segmentation technique that detects points where the increase in voxel intensity is above a certain threshold. Alternatively, or additionally, the segmentation technique may detect the second ROI around one or more points indicated by, for example, a user via a user-interface at workstation 103 during or after the procedure. The segmentation technique may analyze the one or more points, detect and highlight the outline of the second ROI surrounding the one or more points. The user may then choose to modify the second outline via, for example, the user-interface at workstation 103, to improve accuracy.

At 210, pictorial reporting unit 106 automatically determines the location of any structural change based on the first and second outlines. This may be performed by, for example, aligning and comparing the shapes of the first and second outlines and detecting any local change in shape.

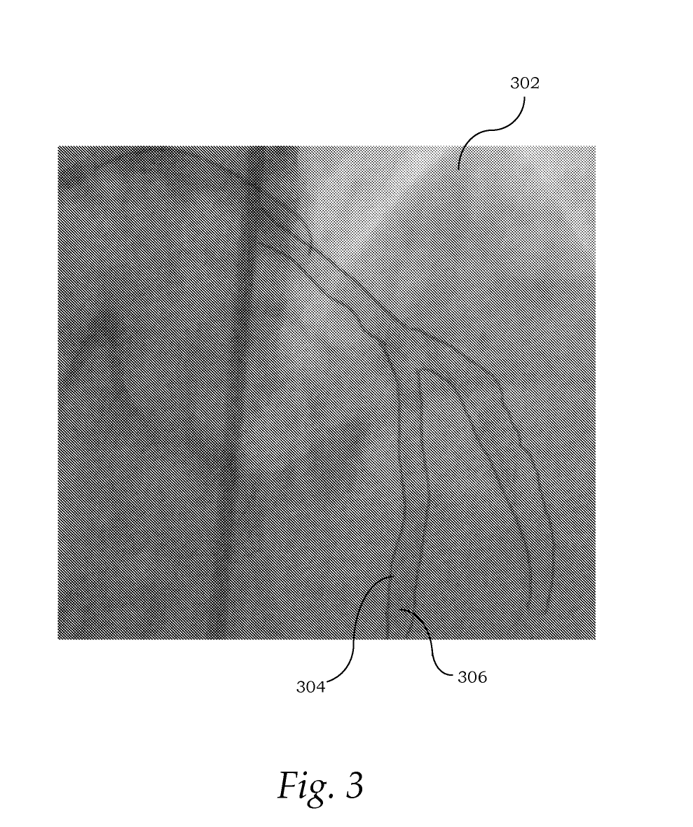

FIG. 3 shows an exemplary post-procedural image 302. The post-procedural image 302 is an angiogram that is generated by injecting a radio-opaque contrast agent into the blood vessels and performing X-ray imaging. The pictorial reporting unit 106 has generated and highlighted the second outline 304 of the blood vessel (or second ROI) 306. The narrowing of the blood vessel has been corrected.

At 212, pictorial reporting unit 106 generates a pictorial report of the medical procedure indicating the location of the structural change. In some implementations, the pictorial report is generated and presented in response to a user selecting, via a user interface (UI), a “pictorial report” button or any other suitable user interface element (e.g., text menu item, icon, etc.). The user interface may be implemented on, for instance, workstation 103. The pictorial report may present the pre-operative and/or post-operative images with the first and/or second outlines highlighted. In addition, the location of structural change caused by the medical procedure may also be indicated on the images or outlines. Further, the pictorial report may include text information about the subject (e.g., patient's name, age, gender, etc.), the medical practitioner (e.g., names of surgeon, assistants, etc.) and the medical procedure (e.g., name, time, date, description, diagnosis, findings, specimens removed, estimated blood loss, etc.). The user may dictate or enter the text of the pictorial report, and/or modify the pictorial report via the user interface.

While the present invention has been described in detail with reference to exemplary embodiments, those skilled in the art will appreciate that various modifications and substitutions can be made thereto without departing from the spirit and scope of the invention as set forth in the appended claims. For example, elements and/or features of different exemplary embodiments may be combined with each other and/or substituted for each other within the scope of this disclosure and appended claims.

1. A reporting system, comprising:
a non-transitory memory device for storing computer readable program code; and
a processor in communication with the memory device, the processor being operative with the computer readable program code to perform steps comprising
generating a first outline of a first region of interest in pre-procedural image data, wherein the pre-procedural image data is acquired, by an imaging device, from a subject before a medical procedure is performed on the subject,
generating a second outline of a second region of interest in post-procedural image data, wherein the second outline corresponds to the first outline and is acquired, by the imaging device, from the subject during or after the medical procedure is performed on the subject,
determining, based on the first and second outlines, a location of a structural change caused by the medical procedure, and
generating a pictorial report of the medical procedure indicating the location of the structural change.

2. The system of claim 1 wherein the pre-procedural image data and the post-procedural image data comprise X-ray angiograms of blood vessels.

3. The system of claim 1 wherein the medical procedure comprises structural repair of a blood vessel or an organ.

4. The system of claim 1 wherein the medical procedure comprises correction of a congenital malformation.

5. The system of claim 1 wherein generating the first outline comprises performing a segmentation technique that detects points with voxels intensities above a pre-determined threshold.

6. The system of claim 1 wherein generating the second outline comprises performing a segmentation technique that detects points with voxels intensities above a pre-determined threshold.

7. The system of claim 1 wherein the pictorial report highlights the first outline, the second outline, or a combination thereof.

8. The system of claim 1 wherein the pictorial report presents the pre-procedural image data, the post-procedural image data, or a combination thereof.

9. The system of claim 1 wherein generating the pictorial report comprises generating the pictorial report in response to a user selection of a user interface element.

10. The system of claim 1 wherein the pictorial report includes text information about the subject and the medical procedure.

11. A non-transitory computer readable medium embodying a program of instructions executable by machine to perform steps for reporting, the steps comprising:
generating a first outline of a first region of interest in pre-procedural image data, wherein the pre-procedural image data is acquired, by an imaging device, from a subject before a medical procedure is performed on the subject;
generating a second outline of a second region of interest in post-procedural image data, wherein the second outline corresponds to the first outline and is acquired, by the imaging device, from the subject during or after the medical procedure is performed on the subject; and
generating a pictorial report of the medical procedure that highlights the first outline, the second outline or a combination thereof.

12. The computer readable medium of claim 11, wherein the steps further comprise
determining a location of a structural change based on the first and second outlines; and
indicating the location of the structural change on the pictorial report.

13. The computer readable medium of claim 11 wherein the pre-procedural image data and the post-procedural image data comprise X-ray angiograms of blood vessels.

14. A method of reporting, comprising:
generating a first outline of a first region of interest in pre-procedural image data, wherein the pre-procedural image data is acquired, by an imaging device, from a subject before a medical procedure is performed on the subject;
generating a second outline of a second region of interest in post-procedural image data, wherein the second outline corresponds to the first outline and is acquired, by the imaging device, from the subject during or after the medical procedure is performed on the subject;
determining, based on the first and second outlines, a location of a structural change caused by the medical procedure; and
generating a pictorial report of the medical procedure indicating the location of the structural change.

15. The method of claim 14 further comprising modifying the first or second outlines in response to user input.

16. The method of claim 14 wherein generating the first outline comprises segmenting the first region of interest around one or more points indicated by a user.

17. The method of claim 14 wherein generating the second outline comprises segmenting the second region of interest around one or more points indicated by a user.

18. The method of claim 14 wherein generating the first outline comprises performing a segmentation technique that detects points with voxels intensities above a pre-determined threshold.

19. The method of claim 14 wherein generating the second outline comprises performing a segmentation technique that detects points with voxels intensities above a pre-determined threshold.

20. The method of claim 14 wherein generating the pictorial report comprises generating the pictorial report in response to a user selection of a user interface element.
